(19) United States
(12) Patent Application Publication
(10) Pub. No.: US 2021/0389912 A1
(43) Pub. Date: Dec. 16, 2021

(54) IMAGE FORMING DEVICE, PAPER FEEDING CONTROL METHOD, AND STORAGE MEDIUM

(71) Applicant: CANON KABUSHIKI KAISHA, Tokyo (JP)

(72) Inventor: Toru Wakana, Chiba (JP)

(21) Appl. No.: 17/336,379

(22) Filed: Jun. 2, 2021

(30) Foreign Application Priority Data
Jun. 15, 2020 (JP) 2020-103281

(51) Int. Cl. G06F 3/12; G06K 15/16

(52) U.S. Cl. CPC G06F 3/121; G06K 15/16; G06F 3/1234

(57) ABSTRACT

According to an aspect of the present disclosure, an image forming device performs printing based on setting information of a print job in a mode giving priority to the setting information, and the device comprises: a feeding unit that feeds paper based on the setting information; a first determining unit that determines whether or not a first paper type is same as a second paper type, the first paper type being the setting information of the print job, and the second paper type being a type set in a paper feeding section; a second determining unit that determines a degree of mismatch between the first and second paper types if the first determining unit determines that the first and second paper types are not the same type, wherein the feeding unit does not feed paper if the second determining unit determines that the degree of mismatch exceeds a threshold value.

### BACKGROUND OF THE INVENTION

### Field of the Invention

The present invention relates to an image forming device, a paper feeding control method, and a storage medium.

### Description of the Related Art

It is known that a user sends document data formed in applications to an image forming device via a printer driver, and then the image forming device performs printing by using an image formed in the image forming device. In addition, a mode called “printer driver setting priority” is also known. The printer driver setting priority mode gives priority to a size and a type of paper specified in a printer driver over a size and a type of paper stored in a paper feeding unit of the image forming device. Japanese Patent Application Laid-Open No. 2018-099840 discloses paper feeding control in the printer driver setting priority mode.

In case of operating the image forming device in the printer driver setting priority mode, however, it is possible that the size and type of paper stored in the paper feeding unit of the image forming device are different from paper information specified in the printer driver. In such a case, the image forming device feeds paper based on the paper information specified in the printer driver. As a result, the image forming device may have problems such as jam or printing errors if the paper information indicates the size and type of paper significantly different from the paper stored in the paper feeding unit.

The present disclosure provides a technique for reducing a frequency of occurrence of the problems such as jam or printing errors when controlling the paper feeding with giving priority to the paper information specified in the printer driver.

### SUMMARY OF THE INVENTION

According to an aspect of the present disclosure, an image forming device performs printing based on setting information of a print job in a mode giving priority to the setting information of the print job, and the device comprises: a feeding unit that feeds paper based on the setting information of the print job; a first determining unit that determines whether or not a first paper type is same as a second paper type, the first paper type being the setting information of the print job, and the second paper type being a type set in a paper feeding section; a second determining unit that determines a degree of mismatch between the first and second paper types if the first determining unit determines that the first and second paper types are not the same type, wherein the feeding unit does not feed paper if the second determining unit determines that the degree of mismatch exceeds a threshold value.

Further features of the present invention will become apparent from the following description of exemplary embodiments with reference to the attached drawings.

### BRIEF DESCRIPTION OF THE DRAWINGS

FIG. 1 is a diagram showing the inner configuration of an image forming device.

FIG. 2 is a block diagram showing an example of the inner configuration of a controller comprised by the image forming device.

FIG. 3 is a diagram showing an example of setting screen for the printer driver setting priority.

FIG. 4 is a diagram showing an example of the configuration of a print job.

FIG. 5 is a table showing an example of paper setting for each paper feeding tray.

FIG. 6 is a table showing an example of classes for basis weight.

FIG. 7 is a flowchart showing a flow of image forming processes.

### DESCRIPTION OF THE EMBODIMENTS

### First Embodiment

The first embodiment for implementing the present invention will be described below with reference to the drawings.

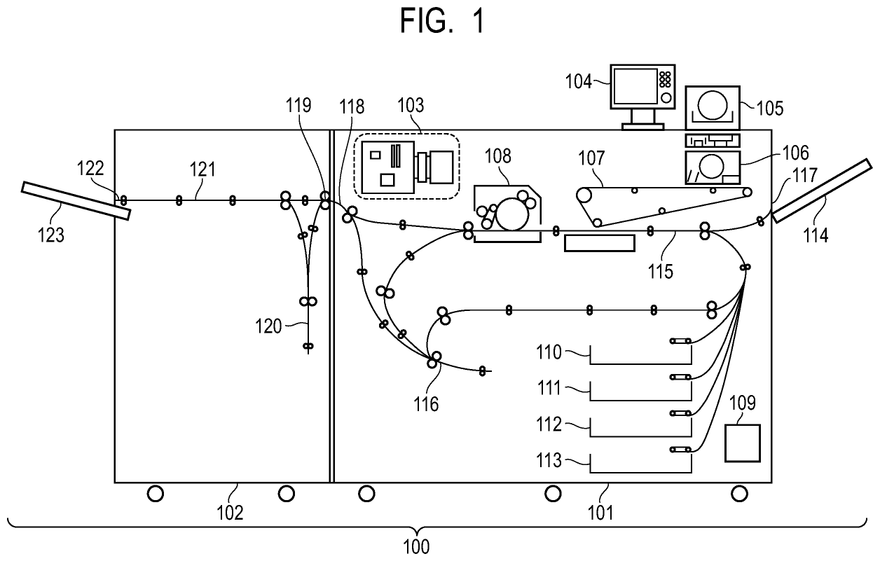

FIG. 1 is a diagram showing the inner configuration of an image forming device 100 according to the present embodiment.

In FIG. 1, the image forming device 100 comprises a printer 101 and a finisher 102.

The printer 101 forms an image and prints the image.

The finisher 102 comprises paper delivery section for delivering paper after printing in the printer 101.

A controller 103 operates software for performing various controls of the image forming device 100.

An operation unit 104 comprises hard keys and a display device including a touch panel to provide instructions of operation for the image forming device 100. The operation unit 104 is operable to display information of the image forming device 100 on the display device, and receive an input for a setting through the touch panel or the hard keys.

A toner supplying unit 105 supplies toner as printing agent for an image forming unit 106 of the image forming device 100. The toner supplying unit 105 comprises a door that allows an operator to supply the toner.

The image forming unit 106 forms an image shown in print data using the toner supplied by the toner supplying unit 105, and transfers the image in an intermediate transfer belt 107. The image transferred in the intermediate transfer belt 107 is further transferred to paper.

A fixing device 108 applies heat and pressure to paper with the image transferred by the intermediate transfer belt 107 for fixing the toner to the paper.

Surplus toner that is not transferred to the paper from the intermediate transfer belt 107 is stored in a surplus toner collecting unit 109.

Paper feeding devices 110 to 114 feed paper. Paper fed from any one of the paper feeding devices 110 to 114 passes through a paper carrying unit 115 to have the toner transfer and fixing processes.

A switchback unit 116 reverses the paper.

A paper delivery unit 118 delivers the paper after having the fixing process to the finisher 102.

An input port 119 is an input port of the finisher 102 for receiving the paper from the printer 101.

A switchback unit 120 reverses the paper. The paper is received at the input port 119 of the finisher 102, and then delivered to a delivery unit 122 through a transport unit 121, and then stored in a delivery tray 123.

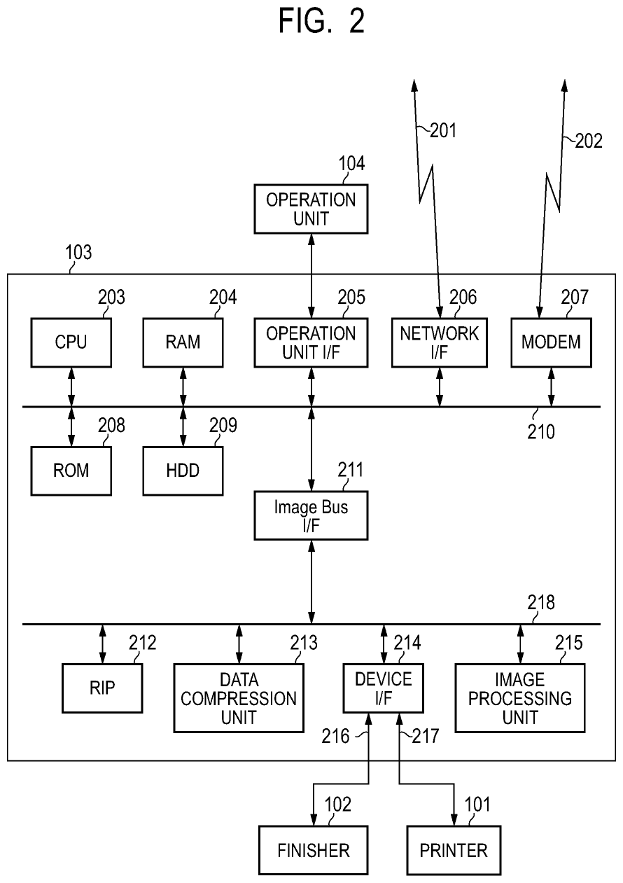

FIG. 2 is a block diagram showing an example of the inner configuration of the controller 103 of the image forming device 100.

A CPU (Central Processing Unit) 203 operates program for totally controlling the controller 103.

A RAM (Random Access Memory) 204 is controlled by program operating on the CPU 203. The RAM 204 is used as a reception buffer for the purpose of temporarily storing data received from outside devices. The RAM 204 is further used as a buffer for the purpose of temporarily storing image data rasterized by RIP (Raster Image Processor) 212. The RIP 212 is described later.

An operation unit I/F 205 is an interface for connecting the operation unit 104 and the controller 103.

A network I/F 206 is an interface for connecting the controller 103 and outside devices through a network 201.

A MODEM (Modulator Demodulator) 207 is an interface for connecting the controller 103 and outside devices through a telephone network 202.

A ROM (Read Only Memory) 208 is a memory for storing data and program operating on the CPU 203.

An HDD (Hard Disk Drive) 209 is a nonvolatile storage device for storing various data for a long period of time.

The above components 203 to 209 are connected through a CPU bus 210.

An image bus I/F 211 is an interface for connecting the CPU bus 210 and an image bus 218.

The RIP 212 is a rasterizer for converting page description language (PDL) data received from outside devices into bitmap image data.

A data compression unit 213 is a data compressor for compressing data.

A device I/F 214 is an interface for connecting the printer 101 and the finisher 102 to the image bus 218 through data buses 216 and 217.

An image processing unit 215 performs various image processes to bitmap image data generated by the RIP 212. The image processing unit 215 is configured to digitally process the bitmap image data such as converting two-page bitmap image data into a single page bitmap image data. In accordance with a signal provided from the operation unit 104 or outside devices through the network 201, the CPU 203 perform printing by providing instructions to perform the printing for the printer 101 and the finisher 102 through the data buses 216 and 217.

The image bus 218 is an image bus connected to a group of hardware to perform the image processing.

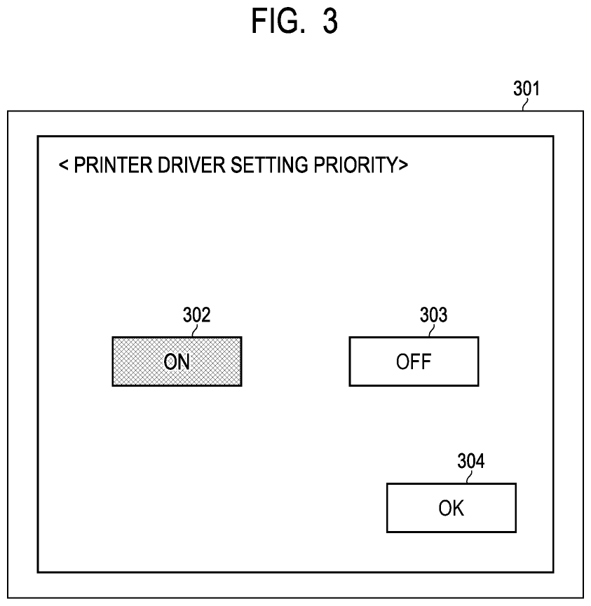

FIG. 3 is a diagram showing an example of setting screen for the printer driver setting priority. The setting screen is displayed on the operation unit 104. The term “printer driver setting priority” indicates a mode that gives priority to a size and a type of paper specified in a print job over a size and a type of paper set in each paper feeding tray of the paper feeding devices 110 to 115.

A setting screen 301 shows the whole setting screen of the printer driver setting priority, and is displayed on a display device including a touch panel comprised by the operation unit 104.

An ON key 302 is a key for activating the printer driver setting priority.

An OFF key 303 is a key for deactivating the printer driver setting priority.

In the screen shown in FIG. 3, the ON key 302 is displayed reversely, which indicates that the printer driver setting priority is activated.

An OK key 304 is a key for validating the present screen setting, and closing the window. A user can activate or deactivate the printer driver setting priority through the screen shown in FIG. 3.

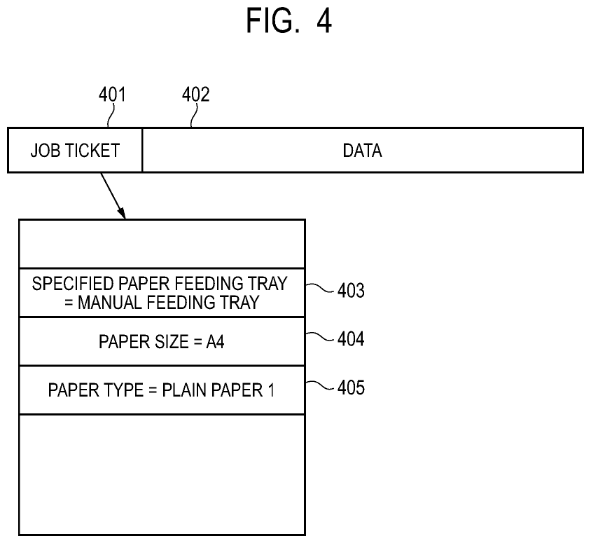

FIG. 4 is a diagram showing an example of the configuration of the print job. As an example of the print job, FIG. 4 shows a print job input from a computer such as a host computer through the network 201. The print job may be a copy job read out by a reading device (not shown) comprised by the image forming device 100, or a print job temporarily stored in the HDD 209 or the RAM 204.

The information of the print setting such as a specified paper size or type, a specified paper feeding rack is stored in a job ticket 401. In the present embodiment, the job ticket 401 is described in the job control language.

In the present embodiment, a print data 402 is the page description language (PDL). As described above, the print data 402 may be print data of a copy job read out by a reading device (not shown), or print data of a print job temporarily stored in a storage device (such as the HDD 209 or the RAM 204).

The information stored in the job ticket 401 is described below.

A paper feeding tray specifying information 403 includes information of a specific paper feeding tray as a print setting. In FIG. 4, a “manual feeding tray” is specified as a paper feeding tray.

A paper size specifying information 404 includes information of a specific paper size as a print setting. In FIG. 4, a size “A4” is specified as a paper size.

A paper type specifying information 405 includes information of a specific paper type as a print setting. In FIG. 4, a type “plain paper 1” is specified as a paper type.

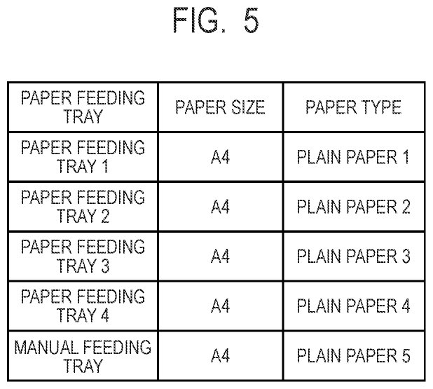

FIG. 5 is a table showing an example of paper information setting for each paper feeding tray of the paper feeding devices 110 to 114. The setting of the paper information indicates a combination of the paper size and the paper type. The setting information of the paper information is stored in the HDD 209.

FIG. 5 shows that a paper size “A4” and a paper type “plain paper 1” is set for a “paper feeding tray 1” of the paper feeding device 110.

FIG. 5 also shows that a paper size “A4” and a paper type “plain paper 3” is set for a “paper feeding tray 3” of the paper feeding device 112.

FIG. 5 also shows that a paper size “A4” and a paper type “plain paper 4” is set for a “paper feeding tray 4” of the paper feeding device 113.

FIG. 5 also shows that a paper size “A4” and a paper type “plain paper 5” is set for a “manual feeding tray” of the paper feeding device 114.

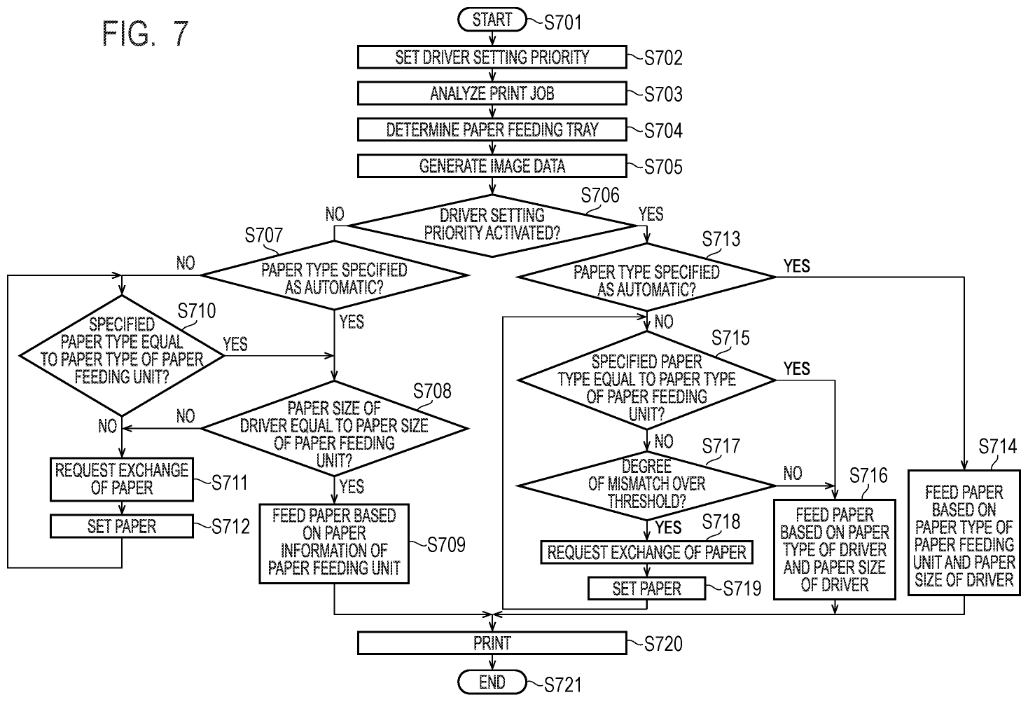

The processing steps of the image formation according to the present embodiment are described below with reference to the flowchart shown in FIG. 7. The symbols S701 to S721 shown in FIG. 7 represent the respective steps.

In S701, the present processing system flow starts.

In S702, the CPU 203 sets the printer driver setting priority in accordance with an instruction received from the operation unit 104. In the present embodiment, the printer driver setting priority is set by user's operation through the screen shown in FIG. 3. The setting values of the printer driver setting priority are stored in the HDD 209 or the RAM 204.

In S703, the CPU 203 analyzes a print job. First, the CPU 203 receives a print job through the network 201, and stores the received print job in the HDD 209 or the RAM 204. Then, the CPU 203 reads out the print job stored in the HDD 209 or the RAM 204, and analyzes the print job. Then, the CPU 203 reads out the paper feeding tray specifying information 403, the paper size specifying information 404, and the paper type specifying information 405 from the job ticket 401 stored in the print job, and stores the respective information in the HDD 209 or the RAM 204. The CPU 203 also analyzes the PDL data of the print data 402, and generates intermediate data based on the PDL data, and stores the intermediate data in the HDD 209 or the RAM 204.

In S704, the CPU 203 determines a paper feeding tray for feeding paper. For example, the CPU 203 determines a paper feeding tray based on the paper feeding tray specifying information 403 read out from the job ticket 401 stored in the print job. If the CPU 203 receives the print job shown in FIG. 4, for example, the paper feeding tray specifying information 403 specifies the “manual feeding tray”, the CPU 203 determines the “manual feeding tray” as a paper feeding tray for feeding paper.

In S705, the CPU 203 reads out the intermediate data stored at S703 from the HDD 209 or the RAM 204, and generates image data using the RIP 212, and stores the image data in the HDD 209 or the RAM 204.

In S706, the CPU 203 determines whether the setting performed at S702 activates the printer driver setting priority. If the printer driver setting priority is activated, the priority is given to the paper size specifying information 404 and the paper type specifying information 405 of the print job as shown in FIG. 4 over the sizes and types of paper stored in the respective paper feeding trays shown in FIG. 5. The above determination is made by the CPU 203 through reading out the setting values of the printer driver setting priority from the HDD 209 or the RAM 204. If the printer driver setting priority is determined to be deactivated, the processing system goes to S707, and the CPU performs the control to deactivate the printer driver setting priority. On the other hand, if the printer driver setting priority is determined to be activated, the processing system goes to S713, and the CPU performs the control to activate the printer driver setting priority.

In S707, the CPU 203 reads out the paper type specifying information 405 from the HDD 209 or the RAM 204, and determines whether the paper type specifying information 405 indicates an “automatic mode”. The “automatic mode” indicated in the paper type specifying information 405 means applying a paper type of the paper feeding tray specified by the paper feeding tray specifying information 403 without any change in the setting. For example, the “manual feeding tray” shown in FIG. 5 is already determined as a paper feeding tray for feeding paper at S704. In case of the setting as shown in FIG. 5, the “plain paper 5” is to be applied as a paper type. If the paper type specifying information 405 is determined to indicate the “automatic mode”, the processing system goes to S708. On the other hand, if the paper type specifying information 405 is not determined to indicate the “automatic mode”, the processing system goes to S710.

In S708, the CPU 203 compares the paper size specified in the paper size specifying information 404 of the print job with the paper size set in the paper feeding tray determined at S704, and then determines whether they are same or not. If the CPU 203 determines that they are same, the processing system goes to S709. If the CPU 203 determines that they are not same, the processing system goes to S711.

In S709, the CPU 203 controls the paper feeding based on the paper size and type set in the paper feeding tray. That is to say, if the paper size specifying information 404 specifies a paper size “A4” as shown in FIG. 4, and the paper size of the paper feeding tray is also set as “A4” as shown in FIG. 5, the paper size of the paper to be fed is set to “A4” because the both of the specified paper sizes are same. If the paper type specifying information 405 indicates the “automatic mode”, and the paper size of the paper feeding tray is set as “plain paper 5”, the paper size of the paper to be fed is set to the “plain paper 5”.

In S710, the CPU 203 compares the paper type specified in the paper type specifying information 405 of the print job with the paper type set in the paper feeding tray determined at S704, and then determines whether they are same or not. If the CPU 203 determines that they are same, the processing system goes to S708. If the CPU 203 determines that they are not same, the processing system goes to S711.

In S711, the CPU 203 instructs the operation unit 104 to display a paper change request. It is determined to need the paper change if the paper type specified in the paper type specifying information 405 is different from the paper type set in the paper feeding tray (“NO” at S710). It is also determined to need the paper change if the paper size specified in the paper size specifying information 404 is different from the paper size set in the paper feeding tray (“NO” at S708).

In S712, the CPU 203 waits until proper paper is set to the paper feeding tray, and then instructs the operation unit 104 to stop displaying the paper change request after setting proper paper. Then, the processing system goes back to S710.

In S713, the CPU 203 reads out the paper type specifying information 405 from the HDD 209 or the RAM 204, and determines whether the paper type specifying information 405 indicates an “automatic mode”. If the paper type specifying information 405 is determined to indicate the “automatic mode”, the processing system goes to S714. On the other hand, if the paper type specifying information 405 is not determined to indicate the “automatic mode”, the processing system goes to S715.

In S714, the CPU 203 determines the paper information for feeding paper in the printer driver setting priority mode. In the present embodiment, the CPU 203 determines that the paper type specifying information 405 indicates the “automatic mode” at S713. Therefore, the paper type is set to the “plain paper 5” if the paper size and type are set in the respective paper feeding trays as shown in FIG. 5. Then, the paper size is set to a size “A4” based on the paper size specifying information 404, as the printer driver setting priority is activated. As a result, the paper feeding control is performed with the setting of “plain paper 5” as a paper type and “A4” as a paper size.

In S715, the CPU 203 compares the paper type specified in the paper type specifying information 405 of the print job with the paper type set in the paper feeding tray determined at S704, and then determines whether they are same or not. If the CPU 203 determines that they are same, the processing system goes to S716. If the CPU 203 determines that they are not same, the processing system goes to S717.

In S716, the CPU 203 determines the paper information for feeding paper in the printer driver setting priority mode. In the present embodiment, the paper type is set to “plain paper 1” based on the paper type specifying information 405. Then, the paper size is set to a size “A4” based on the paper size specifying information 404, as the printer driver setting priority is activated. As a result, the paper feeding control is performed with the setting of “plain paper 1” as a paper type and “A4” as a paper size.

In S717, the CPU 203 determines a degree of mismatch between the paper type specified in the paper type specifying information 405 and the paper type set in the paper feeding tray. If the degree of mismatch is less than a threshold value, it is determined that there is no negative impact on the paper feeding control even though there is some difference between the above paper types, and the processing system goes to S716. On the other hand, If the degree of mismatch exceeds a threshold value, it is determined that there is a negative impact on the paper feeding control due to a difference between the above paper types, and the processing system goes to S718.

The degree of mismatch is described below with showing several examples.

The basis weight is predefined for each paper type. Each paper type has its own basis weight, but the different paper types may have the same basis weight. As an example of determining the degree of mismatch, it may be determined that “the degree of mismatch is less than the threshold” if their basis weight is same, and that “the degree of mismatch exceeds the threshold” if their basis weight is different. As another example, it may be determined that “the degree of mismatch is less than the threshold” if a difference between their basis weight is less than a predetermined difference, and that “the degree of mismatch exceeds the threshold” if a difference between their basis weight exceeds a predetermined difference.

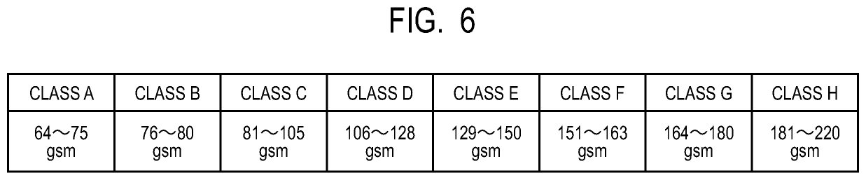

The degree of mismatch may be determined using the basis weight class. FIG. 6 shows an example of classes for the basis weight of paper. As shown in FIG. 6, the basis weight may be defined and classified as “class A” to “class H”. According to the definition shown in FIG. 6, the different paper types may have the same basis weight class. As an example of determining the degree of mismatch, it may be determined that “the degree of mismatch is less than the threshold” if their basis weight class is same, and that “the degree of mismatch exceeds the threshold” if their basis weight class is different. As another example, it may be determined that “the degree of mismatch is less than the threshold” if a difference between their basis weight class is less than a predetermined number of class, and that “the degree of mismatch exceeds the threshold” if a difference between their basis weight class exceeds a predetermined number of class. When a predetermined number of class is set to two and in case of using the classification shown in FIG. 6 for example, it is determined that “the degree of mismatch is less than the threshold” if their difference in class corresponds to a difference between “class A” and “class C”, while it is determined that “the degree of mismatch exceeds the threshold” if their difference in class corresponds to a difference between “class A” and “class D”.

In addition, the surface property is predetermined for each paper type. For example, the surface property has several types such as “high-quality paper”, “recycled paper”, “coated paper”, “embossed paper”, or “film paper”. As an example for determining the degree of mismatch, it may be determined that “the degree of mismatch is less than the threshold” if they have the same surface property even though they have different paper types, while it may be determined that “the degree of mismatch exceeds the threshold” if they have different surface properties.

Furthermore, the paper shape is predetermined for each paper type. For example, the paper shape has several types such as “normal shape”, “tab paper”, “punched paper”, or “envelope”. As an example for determining the degree of mismatch, it may be determined that “the degree of mismatch is less than the threshold” if they have the same paper shape even though they have different paper types, while it may be determined that “the degree of mismatch exceeds the threshold” if they have different paper shapes.

Furthermore, the conveying speed for feeding the paper is predetermined for each paper type. For example, the conveying speed has several types such as “normal speed”, “⅚ speed”, or “half speed”. As an example for determining the degree of mismatch, it may be determined that “the degree of mismatch is less than the threshold” if they have the same conveying speed even though they have different paper types, while it may be determined that “the degree of mismatch exceeds the threshold” if they have different conveying speeds.

Furthermore, the fixing temperature for fixing toner to the paper is predetermined for each paper type based on the characteristics of paper types. As an example for determining the degree of mismatch, it may be determined that “the degree of mismatch is less than the threshold” if they have the same fixing temperature even though they have different paper types, while it may be determined that “the degree of mismatch exceeds the threshold” if they have different fixing temperatures.

The method for determining the degree of mismatch according to the present embodiment may be predefined for each image forming device. Alternatively, the above method for determining the degree of mismatch may be set by user's operation through a setting screen displayed on the operation unit 104. In addition, the method for determining the degree of mismatch may be specified in the job ticket of the print job.

In S718 and S719, the same processes performed at S711 and S712 are performed, respectively.

In S720, the CPU 203 reads out the image data generated by the process at S705 from the HDD 209 or the RAM 204. Then, the CPU 203 converts the image data read out from the HDD 209 or the RAM 204 into a video signal to perform printing on the paper fed from the paper feeding tray.

In S721, the present processing system ends.

In the present embodiment, the print job is described to include the PDL data. However, the scope of the present disclosure is not limited to the above example, and is also applicable with other job types (such as a copy job or an accumulated print job).

According to the present embodiment, the degree of mismatch is determined if the printer driver setting priority is activated and also the paper type specified in the print job is different from the paper type set in the paper feeding tray. Then, the paper feeding control is performed based on the paper type specified in the print job only if the degree of mismatch is less than a threshold value. This configuration allows to reduce a frequency of occurrence of the problems such as jam or printing errors.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-103281, filed on Jun. 15, 2020, which is hereby incorporated by reference herein in its entirety.

What is claimed is:

1. An image forming device configured to perform printing based on setting information of a print job in a mode giving priority to the setting information of the print job, the device comprising:
a feeding unit configured to feed paper based on the setting information of the print job;
a first determining unit configured to determine whether or not a first paper type is same as a second paper type, the first paper type being the setting information of the print job, and the second paper type being a type set in a paper feeding section;
a second determining unit configured to determine a degree of mismatch between the first and second paper types if the first determining unit determines that the first and second paper types are not the same type,
wherein the feeding unit is configured not to feed paper if the second determining unit determines that the degree of mismatch exceeds a threshold value.

2. The image forming device according to claim 1, wherein the second determining unit is configured to determine the degree of mismatch based on a comparison between a first basis weight of the first paper type and a second basis weight of the second paper type.

3. The image forming device according to claim 2, wherein the second determining unit is configured to determine that the degree of mismatch exceeds the threshold value if the second determining unit determines that the first basis weight is different from the second basis weight as a result of the comparison.

4. The image forming device according to claim 2, wherein the second determining unit is configured to determine that the degree of mismatch exceeds the threshold value if the second determining unit determines that a difference between the first and second basis weights exceeds a predetermined value as a result of the comparison.

5. The image forming device according to claim 2, wherein, in case of dividing the basis weight in a predetermined number of classes, the second determining unit is configured to determine that the degree of mismatch exceeds the threshold value if the second determining unit determines that a first class of the first basis weight is different from a second class of the second basis weight.

6. The image forming device according to claim 2, wherein, in case of classifying basis weight in a predetermined number of classes, the second determining unit is configured to determine that the degree of mismatch exceeds the threshold value if the second determining unit determines that a difference between a first class of the first basis weight and a second class of the second basis weight exceeds a predetermined number of class.

7. The image forming device according to claim 1, wherein the second determining unit is configured to determine the degree of mismatch based on a comparison between a first surface property of the first paper and a second surface property of the second paper.

8. The image forming device according to claim 7, wherein the second determining unit is configured to determine that the degree of mismatch exceeds the threshold value if the second determining unit determines that the first surface property is different from the second surface property as a result of the comparison.

9. The image forming device according to claim 1, wherein the second determining unit is configured to determine the degree of mismatch based on a comparison between a first shape of the first paper type and a second shape of the second paper type.

10. The image forming device according to claim 9, wherein the second determining unit is configured to determine that the degree of mismatch exceeds the threshold value if the second determining unit determines that the first shape is different from the second shape as a result of the comparison.

11. The image forming device according to claim 1, wherein the second determining unit is configured to determine the degree of mismatch based on a comparison between a first conveying speed for feeding paper of the first paper type and a second conveying speed for feeding paper of the second paper type.

12. The image forming device according to claim 11, wherein the second determining unit is configured to determine that the degree of mismatch exceeds the threshold value if the second determining unit determines that the first conveying speed is different from the second conveying speed as a result of the comparison.

13. The image forming device according to claim 1, wherein the second determining unit is configured to determine the degree of mismatch based on a comparison between a first fixing temperature for performing printing on paper of the first paper type and a second fixing temperature for performing printing on paper of the second paper type.

14. The image forming device according to claim 13, wherein the second determining unit is configured to determine that the degree of mismatch exceeds the threshold value if the second determining unit determines that the first fixing temperature is different from the second fixing temperature as a result of the comparison.

15. The image forming device according to claim 1, wherein the second determining unit is configured to determine the degree of mismatch based on a determining manner instructed through the print job.

16. The image forming device according to claim 1 further comprising an instructing unit configured to receive an instruction of a determining manner for the degree of mismatch from an operation unit,
wherein the second determining unit is configured to determine the degree of mismatch based on the determining manner instructed by the instructing unit.

17. The image forming device according to claim 1, wherein the print job is described in a page description language.

18. The image forming device according to claim 1, wherein the print job is described in a job control language.

19. A method of controlling paper feeding of an image forming device configured to perform printing based on setting information of a print job in a mode giving priority to the setting information of the print job, the method comprising:
feeding paper based on the setting information of the print job;
first determining whether or not a first paper type is same as a second paper type, the first paper type being the setting information of the print job, and the second paper type being a type set in a paper feeding section;
second determining a degree of mismatch between the first and second paper types if the first determining determines that the first and second paper types are not the same type,
wherein the feeding does not feed paper if the second determining determines that the degree of mismatch exceeds a threshold value.

20. A non-transitory computer-readable storage medium storing a program that, when executed by a computer, causes the computer to perform a method of controlling paper feeding of an image forming device configured to perform printing based on setting information of a print job in a mode giving priority to the setting information of the print job, the method comprising:
feeding paper based on the setting information of the print job;
first determining whether or not a first paper type is same as a second paper type, the first paper type being the setting information of the print job, and the second paper type being a type set in a paper feeding section;
second determining a degree of mismatch between the first and second paper types if the first determining determines that the first and second paper types are not the same type,
wherein the feeding does not feed paper if the second determining determines that the degree of mismatch exceeds a threshold value.
